(19) United States
(12) Patent Application Publication
(10) Pub. No.: US 2015/0376799 A1
(43) Pub. Date: Dec. 31, 2015

(54) NON-PHOSPHOROUS CONTAINING CORROSION INHIBITORS FOR AQUEOUS SYSTEMS

(71) Applicant: BAKER HUGHES INCORPORATED, Houston, TX (US)

(72) Inventors: Mary Jane Legaspi Felipe, Sugar Land, TX (US); Corina Sandu, Pearland, TX (US); David N. Fulmer, Missouri City, TX (US); Bing Bing Guo, Missouri City, TX (US)

(73) Assignee: BAKER HUGHES INCORPORATED, Houston, TX (US)

(21) Appl. No.: 14/319,668

(22) Filed: Jun. 30, 2014

(51) Int. Cl. C23F 11/04; C02F 1/68; C01B 5/00

(52) U.S. Cl. CPC C23F 11/04; C01B 5/00; C02F 1/68; C02F 2303/22

(57) ABSTRACT

Hydroxycarboxylic acids and/or transition metal salts may be added to an aqueous system to inhibit corrosion and/or scale deposition within the aqueous system. In a non-limiting embodiment, a phosphorous-containing component may not be added to or include in the aqueous system. The hydroxycarboxylic acid may have two or more carboxylic acid groups. The transition metal salt may have or include a transition metal, such as but not limited to, Zn (II), Zn (IV), Sn, Al, Mn, and combinations thereof. The aqueous system may be or include a cooling tower, a cooling water system, and combinations thereof.

### TECHNICAL FIELD

The present invention relates to treated aqueous systems and methods for treating aqueous systems, and more specifically relates to adding hydroxycarboxylic acids or hydrocarboxylic acid salts, and transition metal salts to aqueous systems to decrease corrosion and/or scale deposition.

### BACKGROUND

The problems of corrosion and attendant effects, such as pitting, have troubled water systems for years. For instance, scale tends to accumulate on internal walls of various water systems, and thereby materially lessens the operational efficiency of the system. In this manner, heat transfer functions of the particular system are severely impeded.

Corrosion is a derivative electrochemical reaction of a metal with its environment. It is the reversion of refined metals to their natural state. For example, iron ore is iron oxide. Iron oxide is refined into steel. When the steel corrodes, it may form iron oxide. Iron oxide, if unattended, may result in failure or destruction of the metal, causing the particular water system to be shut down until the necessary repairs can be made.

Water systems often have cooling water systems for cooling a water stream to a lower temperature and rejecting heat to the atmosphere. Cooling water towers may use the evaporation of water to remove process heat and cool the working fluid to near the wet-bulb air temperature, or may rely solely on air to cool the working fluid to near the dry-bulb air temperature in the case of a closed circuit dry cooling tower.

Typically, in cooling water systems, corrosion along with pitting has proven deleterious to the overall efficiency of the system. Many cooling water systems employ orthophosphate to decrease corrosion by promoting passivation of the metal surfaces in contact with the system water. However, current costs of phosphorous-based inhibitors have increased due to increased demand of P₂O₅ ores for agricultural fertilizers. Also, environmental regulations in the United States and Europe have increased restriction on phosphate discharge into local rivers and streams. In addition, there is an increasing concern on the phosphorous reserve in the world. A phosphorous crisis is probably not imminent, but phosphorous rock is a non-renewable resource and should be used as efficiently as possible.

Accordingly, the number of low or no phosphate treatment programs have been increasing with a concurrent emphasis on all or predominantly organic treatment programs that typically require relatively higher treatment dosages (i.e., >50 ppm) to be effective. Unfortunately, these high level organic treatment dosages increase the biological food in the system (carbon footprint) and increase the need for feed of toxic biocidal components to the system.

Zinc has been used to inhibit corrosion of metals, and soluble zinc salts are ingredients of many corrosion treatment programs. However, zinc salts may precipitate, particularly in cooling water. For example, when orthophosphate and zinc are both present in an aqueous system, zinc phosphate precipitation becomes a concern. Precipitation of zinc in other forms may also occur, such as zinc oxide or zinc sulfate. The retention of the respective salt constituents in ionic form, i.e. the solubility, depends upon such factors as water temperature, pH, ion concentration, and the like.

In alkaline waters, particularly above about pH 7.5, dissolved zinc tends to deposit out or drop out. Zinc salts are also known to be unstable in neutral or alkaline water and will precipitate with phosphates. Thus, if any of these conditions are present, the aqueous system becomes prone to zinc precipitation. With the formation of zinc scale, many of the surfaces in contact with the aqueous system may foul, and the amount of effective corrosion inhibitor present in the aqueous system may be significantly decreased.

Thus, it would be desirable if methods and compositions for corrosion inhibition and/or scale inhibition could be devised that do not include phosphorous-containing components and/or do not have precipitates formed therefrom.

### SUMMARY

There is provided, in one form, a method for adding a hydroxycarboxylic acid and a transition metal salt to an aqueous system in an effective amount to decrease at least one characteristic within the aqueous system, such as but not limited to, corrosion, scale deposition, and combinations thereof as compared to an otherwise identical aqueous system absent the hydroxycarboxylic acid(s) and the transition metal salt(s). Adding the hydroxycarboxylic acid and the transition metal salt may occur at the same time or different times. ‘Hydroxycarboxylic acid’ as defined herein includes its respective hydrocarboxylic acid salt, i.e. the mention of saccharic acid or other hydroxycarboxylic acids includes the saccharic acid salt. Such hydroxycarboxylic acid salts may be or include potassium, calcium, sodium, ammonium, and combinations thereof. ‘Corrosion’ is defined herein to include general corrosion, such as rust, as well as pitting corrosion. ‘Pitting corrosion’ is defined as a specific type of corrosion concentrated in a certain area that forms a pit or divot in the surface.

There is further provided in another non-limiting embodiment of the method where the hydroxycarboxylic acid may be or include, but is not limited to, saccharic acid, citric acid, tartaric acid, mucic acid, gluconic acid, dehydroxylated dicarboxylic acid, and combinations thereof. The transition metal salt may be or include a transition metal, such as but not limited to, Zn (II), Zn (IV), Sn, Al, Mn, and combinations thereof.

In another non-limiting embodiment, a treated aqueous system may include an aqueous system, at least one hydroxycarboxylic acid in an amount ranging from about 15 ppm to about 500 ppm, and at least one transition metal salt in an amount ranging from about 0.5 ppm to about 20 ppm. The treated aqueous composition may include a decreased amount of at least one characteristic selected from the group consisting of corrosion, scale deposition, and combinations thereof as compared to an otherwise identical aqueous system absent the hydroxycarboxylic acid(s) and the transition metal salt(s).

In an alternative embodiment of the treated aqueous system, the hydroxycarboxylic acid(s) may be or include, but is not limited to, saccharic acid, citric acid, tartaric acid, mucic acid, gluconic acid, dehydroxylated dicarboxylic acid, and combinations thereof, the transition metal salt(s) may be or include at least one transition metal, such as but not limited to Zn (II), Zn (IV), Sn, Al, Mn, and combinations thereof.

### BRIEF DESCRIPTION OF THE DRAWINGS

FIG. 1 is a graph illustrating the corrosion rates of aqueous systems having different components therein;

FIG. 2 is a graph illustrating the corrosion rates for each aqueous system having a different hydroxycarboxylic acid;

FIG. 3 is a graph illustrating the corrosion rates for aqueous systems having different hardness chemistries;

FIG. 4 is a graph illustrating the corrosion rates for aqueous systems having different pH levels;

FIG. 5 is a graph illustrating the measured corrosion rates after a biocide was added to aqueous systems under different conditions;

FIG. 6 is a graph illustrating the corrosion rates of the aqueous systems having different taggants; and

FIG. 7 is a graph illustrating the intensity of the taggants within aqueous systems after corrosion inhibition testing.

### DETAILED DESCRIPTION

It has been discovered that corrosion to a metal surface within an aqueous system and/or scale deposition within the aqueous system may be decreased or inhibited by adding at least one hydroxycarboxylic acid and at least one transition metal salt to the aqueous system. In a non-limiting embodiment, pitting may be decreased, which is a type of localized corrosion that leads to the creation of small holes in the metal surface. The metal surface may be or include, but is not limited to an iron-containing surface, such as steel; an aluminum-containing surface; yellow metals, such as copper and copper alloys; and combinations thereof.

The hydroxycarboxylic acid(s) and the transition metal salt(s) may suppress or reduce the amount of corrosion and/or scale deposition within the aqueous system. That is, it is not necessary for corrosion and/or scale deposition to be entirely prevented for the methods and compositions discussed herein to be considered effective, although complete prevention is a desirable goal. Success is obtained if less corrosion and/or scale deposition occurs using the hydroxycarboxylic acid and the transition metal salt than in the absence of the hydroxycarboxylic acid and the transition metal salt. Alternatively, the methods and treated aqueous systems described are considered successful if there is at least a 50% decrease in corrosion and/or scale deposition within the aqueous system.

The additive and/or the aqueous system may function properly in the presence of phosphorous-containing components. However, in a non-limiting embodiment, the additive does not include a phosphorous-containing compound, such as but not limited to, orthophosphates, polyphosphates, phosphonates, and combinations thereof. The amount of phosphorous-containing components within the aqueous system prior to the addition of the additive may be less than 10 ppm, or less than about 2 ppm in another non-limiting embodiment. Alternatively, the amount of phosphorous-containing components within the aqueous system may range from about 0 independently to about 0.1 ppm or independently to about 0.2 ppm. As used herein with respect to a range, “independently” means that any threshold may be used together with another threshold to give a suitable alternative range, e.g. about 0 ppm independently to about 10 ppm is also considered a suitable alternative range.

The hydroxycarboxylic acid and the transition metal salt may be added to the aqueous system at the same time as an additive, or the two components may be added at different times. The ratio of the hydroxycarboxylic acid to the transition metal salt may range from about 100:12 independently to about 15:0.5, or from about 72:8 independently to about 20:1. When added at the same time, the amount of the additive to be added to the aqueous system may range from about 16 ppm independently to about 5000 ppm, or from about 21 independently to about 600.

The hydroxycarboxylic acid may have or include two or more carboxylic acid groups, alternatively from about two to about ten carboxylic acid groups, or from about three to about eight carboxylic acid groups. In a non-limiting embodiment, the hydrocarboxylic acid may be or include, but is not limited to, saccharic acid, citric acid, tartaric acid, mucic acid, dehydroxylated dicarboxylic acids, gluconic acid, and combinations thereof. The amount of the hydroxycarboxylic acid to be added to the aqueous system may range from about 15 ppm to about 500 ppm, alternatively from about 20 ppm independently to about 300 ppm, or from about 50 ppm independently to about 100 ppm.

The transition metal salt may have or include transition metal, such as but not limited to, Zn (II), Zn (IV), Sn, Al, Mn, and combinations thereof. The salt may be or include, but is not limited to, chlorides, sulfates, hydroxides, oxides, and combinations thereof. The amount of the transition metal salt to be added to the aqueous system may range from about 0.5 ppm to about 100 ppm, alternatively from about 6 ppm independently to about 20 ppm, or 12 ppm independently to about 18 ppm.

At least one additional component may be added to the aqueous system at the same time or different time as the hydroxycarboxylic acid and/or the transition metal salt. Alternatively, the additional component(s) may be present in the aqueous system prior to the addition of the hydroxycarboxylic acid and/or transition metal salt. The additional component may be or include, but is not limited to a scale inhibitor, a biocide, a taggant, a yellow metal corrosion inhibitor, and combinations thereof. The scale inhibitor may be or include, but is not limited to, polyacrylates, polymaleates, hydroxypropylacrylates, phosphonates, and combinations thereof. The polyacrylates may be or include homopolymers, copolymers, terpolymers, and combinations thereof. The scale inhibitor may be present in the aqueous system or may be added to the aqueous system in an amount ranging from about 1 ppm to about 100 ppm, alternatively from about 5 ppm independently to about 50 ppm, or from about 10 ppm independently to about 25 ppm in another non-limiting embodiment. In the alternative, the aqueous system and/or additive does not include polyacrylates or other polymer components.

The biocide may be or include, but is not limited to, sodium hypochlorite (also known as bleach), NaHClO, chlorine dioxide, chlorine, bromine, non-oxidizing biocides, and combinations thereof. Non-limiting examples of the non-oxidizing biocides may be or include isothiazoline; glutaraldehyde; 2,2-dibromo-3-nitrilopropionamide (DBNPA); and combinations thereof. The amount of the biocide present in the aqueous system or added to the aqueous system may range from about 1 ppm independently to about 100 ppm, alternatively from about 5 ppm independently to about 50 ppm, or from about 10 ppm independently to about 25 ppm in another non-limiting embodiment.

In a non-limiting embodiment, a chemical tag may be attached to at least one of the components for purposes of tracing the component added to or present in the aqueous system, such as the hydroxycarboxylic acid, the transition metal salt, the biocide, the scale inhibitor, and combinations thereof. The chemical tag may be or include a fluorophore in a non-limiting embodiment, i.e. a chemical that emits light at a certain wavelength of light. The chemical tag may be or include a tagged polymer, p-Toluenesulfonic acid (pTSA), the scale inhibitor itself as a tag, and combinations thereof. Said differently, the scale inhibitor may act as a fluorophore when added to the aqueous system. Non-limiting examples of the scale inhibitor that may act as a fluorophore may be or include BELCLENE 200™ supplied by BWA Water Additives (a calcium carbonate scale inhibitor), Optidose™ supplied by DOW Chemical Company (a calcium phosphate scale inhibitor, and combinations thereof. The chemical tag may emit light at wavelengths ranging from about 180 independently to about 600, or from about 240 independently to about 350.

The chemical tag may be added to the system at the same time or different time from the hydroxycarboxylic acid and/or transition metal salt. The amount of the chemical tag added to the aqueous system may range from about 1 ppb independently to about 10 ppm, or from about 500 parts per billion (ppb) independently to about 6 ppm in another non-limiting embodiment. Alternatively, the amount of the ‘inherent tag’ added to the aqueous system may range from about 1 ppm independently to about 15 ppm, or from about 2 ppm independently to about 6 ppm. In another non-limiting embodiment, the amount of pTSA added to the aqueous system may range from about 1 ppb independently to about 4 ppm, or from about 100 ppb independently to about 1 ppm.

‘Aqueous system’ is defined herein to include an aqueous-based fluid and any components therein (e.g. pipes or conduits where the aqueous fluid may flow through or alongside) prior to adding the hydroxycarboxylic acid and/or transition metal salts. The aqueous-based fluid may be or include, but is not limited to, water, brine, seawater, and combinations thereof. In a non-limiting embodiment, the aqueous based fluid may circulate through a cooling tower, a cooling water system, and combinations thereof. The cooling tower may be or include an open loop cooling tower, a closed loop cooling tower, and combinations thereof. ‘Open loop’ differs from ‘closed loop’ in that the ‘open loop’ system has recirculating water therethrough. The pH of the aqueous system may be greater than about 7, alternatively from about 7 to about 9, or from about 7.3 to about 8.5 in another non-limiting embodiment.

The aqueous system may be stable in the presence of chlorine-containing components, such as chloride salts different from the transition metal salts. The chlorine-containing components may be present in the aqueous system prior to the addition of the hydroxycarboxylic acid(s) and/or transition metal salt(s). Alternatively, the chlorine-containing components may be added to the aqueous system at the same time or different time as the hydroxycarboxylic acid(s) and/or transition metal salt(s) in an amount ranging from about 1 ppm to about 1,000 ppm, alternatively from about 200 ppm independently to about 800 ppm, or an amount greater than about 500 ppm in another non-limiting embodiment.

The invention will be further described with respect to the following Examples, which are not meant to limit the invention, but rather to further illustrate the various embodiments.

### EXAMPLES

### Example 1

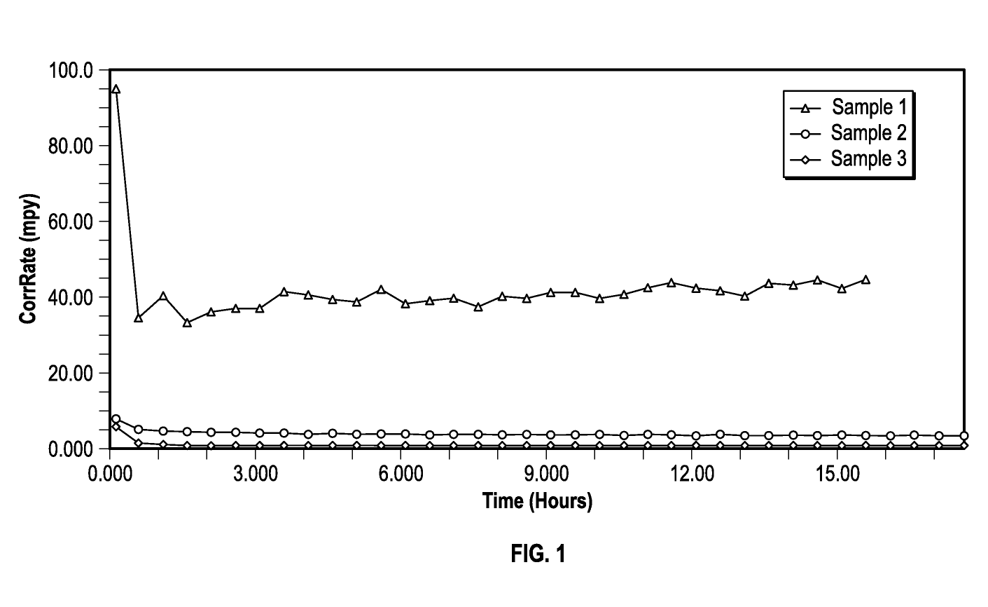

FIG. 1 is a graph illustrating the corrosion rates of aqueous systems having different components therein. The aqueous-based fluid within each aqueous system was water, and the water chemistry included 544 mg/L Na⁺, 142 mg/L Ca⁺², 37 mg/L Mg⁺², 269 mg/L HCO₃⁻, 540 mg/L Cl⁻, 680 mg/L SO₄². The aqueous-based fluid also included 4 ppm of a calcium carbonate scale inhibitor and 4 ppm of a calcium phosphate scale inhibitor. The aqueous-based fluid within each system also had a pH of 8.5.

Sample 1 was the ‘control’ and did not have anything added to the aqueous system.

50 ppm saccharic acid was added to Sample 2. The corrosion rate was 3.777 mils penetration per year (mpy), and the inhibition percentage was 90.48%. However, blemishes to the metal were observed when the saccharic acid was used in the absence of a metal salt.

50 ppm saccharic acid and 6 ppm Zn (II) was added to Sample 3. Sample 3 had a corrosion rate of 0.941 mpy, and a percent inhibition of 97.63%. No pitting or blemishes were observed when the transition metal salt was used in conjunction with the saccharic acid.

### Example 2

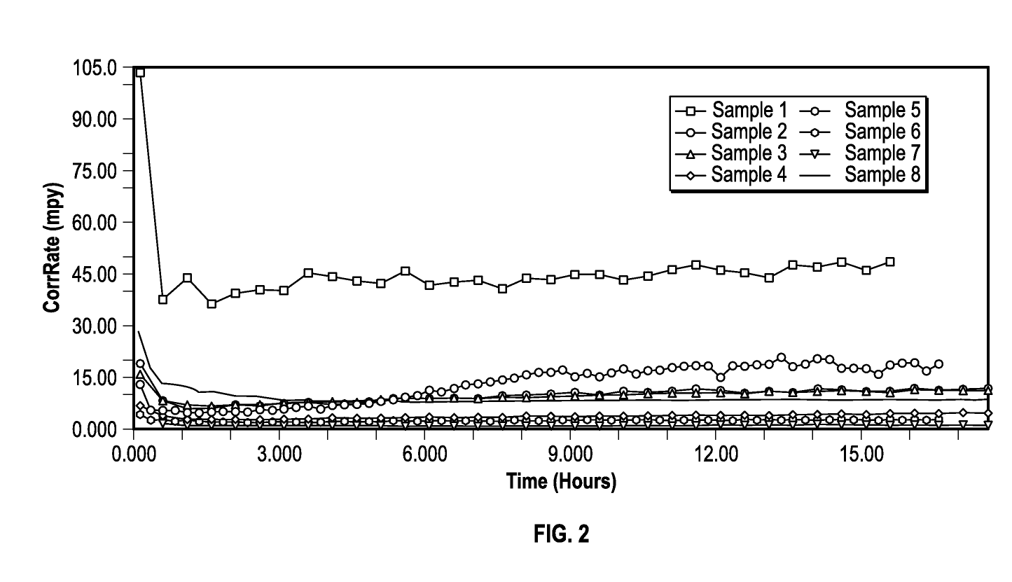

FIG. 2 is a graph illustrating the corrosion rates for aqueous systems having different hydroxycarboxylic acids. The aqueous-based fluid within each aqueous system was water, and the water chemistry included 544 mg/L Na⁺, 142 mg/L Ca⁺², 37 mg/L Mg⁺², 269 mg/L HCO₃⁻, 540 mg/L Cl⁻, 680 mg/L SO₄⁻². The aqueous-based fluid within Samples 1-7 included 6 ppm Zn(II), 4 ppm of a calcium carbonate scale inhibitor, and 4 ppm of a calcium phosphate scale inhibitor. Sample 8 had an aqueous-based fluid with the same water chemistry as samples 1-7, but Sample 8 also included 12 ppm of orthophosphates, 2 ppm Zn(II), 4 ppm of a calcium carbonate inhibitor, and 4 ppm of a calcium phosphate inhibitor. The aqueous-based fluid within each system also had a pH of 8.5.

Sample 1 was the control and did not have anything added thereto.

60 ppm of tartaric acid was added to Sample 2. The corrosion rate was 12.09 mpy, the percent inhibition was 70.8, and pitting was observed.

60 ppm of a mixture of adipic acid, glutaric acid and succinic acid (dehydroxylated dicarboxylic acids) were added to Sample 3. The corrosion rate was 9.35 mpy, the percent inhibition was 76.5, and there was 1-2 pits observed.

60 ppm citric acid was added to Sample 4. The corrosion rate was 3.48 mpy, the percent inhibition was 91.2, and there was no pitting observed.

60 ppm of gluconic acid was added to Sample 5. The corrosion rate was 8.91 mpy, the percent inhibition was 77.5 and moderate pitting was observed.

60 ppm of mucic acid was added to Sample 6. The corrosion rate was 2.23 mpy, the percent inhibition was 94.6, and there was no pitting observed.

60 ppm of saccharic acid was added to Sample 7. The corrosion rate was 0.941 mpy, the corrosion inhibition was 97.6, and there was no pitting observed.

The corrosion rate for Sample 8 was 8.821 mpy, the corrosion inhibition was 78.7, and there was pitting observed.

As noted from FIG. 2, three hydrocarboxylic acids or hydrocarboxylic acid salts including saccharic acid, mucic acid, and citric acid gave more than 90% inhibition with no pitting corrosion observed. These values are higher than the typical phosphorous-Zn program (Sample 8) run in a cooling tower in this aqueous system. Saccharic acid had the lowest corrosion rate of the eight aqueous systems tested.

### Example 3

Several aqueous systems were tested for corrosion rate and percent inhibition having various components, which are noted below in TABLE 1.

Sample 1 included 50 ppm of saccharic acid, 6 ppm of Zn(II) salt, 4 ppm of a calcium carbonate scale inhibitor, and 4 ppm of a calcium phosphate scale inhibitor. The aqueous system had a corrosion rate of 1.10 mpy, a percent inhibition of 97.2, and no pitting or scales were observed.

Sample 2 included 25 ppm of saccharic acid, 1 ppm of Zn(II) salt, 4 ppm of a calcium carbonate scale inhibitor, and 4 ppm of a calcium phosphate scale inhibitor. The aqueous system had a corrosion rate of 1.91 mpy, a percent inhibition of 95.2, and 1 pit was observed but no scales were observed.

Sample 3 included 35 ppm of saccharic acid, 0.5 ppm of Zn(II) salt, 4 ppm of a calcium carbonate scale inhibitor, and 4 ppm of a calcium phosphate scale inhibitor. The aqueous system had a corrosion rate of 4.36 mpy, a percent inhibition of 89.01. A slight yellow solution and pitting was observed.

Sample 4 included 35 ppm of saccharic acid, 1.5 ppm of Zn(II) salt, 4 ppm of a calcium carbonate scale inhibitor, and 4 ppm of a calcium phosphate scale inhibitor. The aqueous system had a corrosion rate of 2.49 mpy, a percent inhibition of 93.72, and 1-2 pits were observed.

Sample 5 included 35 ppm of saccharic acid, 1 ppm of Zn(II) salt, 4 ppm of a calcium carbonate scale inhibitor, and 4 ppm of a calcium phosphate scale inhibitor. The aqueous system had a corrosion rate of 1.87 mpy, a percent inhibition of 95.28, and no pitting or scales were observed.

Sample 6 included 25 ppm of saccharic acid, 1.5 ppm of Zn(II) salt, 4 ppm of a calcium carbonate scale inhibitor, and 4 ppm of a calcium phosphate scale inhibitor. The aqueous system had a corrosion rate of 4.42 mpy, a percent inhibition of 88.86, and 3 pits were observed within a slightly yellow solution.

Sample 7 included 10 ppm of saccharic acid, 0.5 ppm of Zn(II) salt, 4 ppm of a calcium carbonate scale inhibitor, and 4 ppm of a calcium phosphate scale inhibitor. The aqueous system had a corrosion rate of 24.58 mpy, a percent inhibition of 38.07, and pitting was observed within a slightly yellow solution.

TABLE 1
Saccharic Acid Formulation for Corrosion Inhibition

| | | | Scale | Corr. | (%) | |
|---|---|---|---|---|---|---|
| | SA | Zn(II) | Inhibitor | Rate | Inhi- | |
| Sample | (ppm) | (ppm) | (ppm) | (mpy) | bition | Observation |
| 1 | 50 | 6 | 8 | 1.10 | 97.2 | No pitting, no |
| | | | | | | scales |
| 2 | 25 | 1 | 8 | 1.91 | 95.2 | 1 pit, no scales |
| 3 | 35 | 0.5 | 8 | 4.36 | 89.01 | Slight yellow |
| | | | | | | solution/pitting |
| | | | | | | observed |
| 4 | 35 | 1.0 | 8 | 2.49 | 93.72 | 1-2 pits |
| 5 | 35 | 1.5 | 8 | 1.87 | 95.28 | No pitting, no |
| | | | | | | scales |
| 6 | 25 | 1.5 | 8 | 4.42 | 88.86 | More than 3 |
| | | | | | | pits observed/ |
| | | | | | | slight yellow |
| | | | | | | solution |
| 7 | 10 | 0.50 | 8 | 24.58 | 38.07 | Pitting |
| | | | | | | observed/ |
| | | | | | | yellow solution |

### Example 4

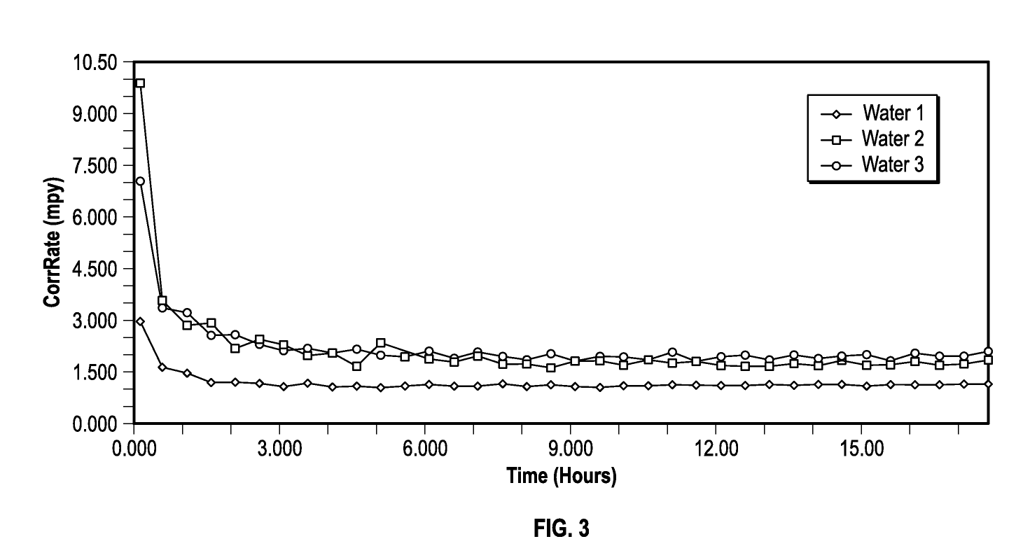

FIG. 3 is a graph illustrating the corrosion rates for aqueous systems having different hardness chemistries. The chemistry of each aqueous system is noted in TABLE 2. The pH of each system was 8.5. Each aqueous system included 35 ppm of saccharic acid, 1.5 ppm of a Zn(II) salt, 4 ppm of a calcium carbonate scale inhibitor, and 4 ppm calcium phosphate scale inhibitor. As noted in FIG. 3, the ‘Water 1’ aqueous system had the lowest corrosion rate, and the ‘Water 3’ aqueous system had the highest corrosion rate.

TABLE 2
WATER COMPOSITIONS FOR AQUEOUS SYSTEMS

| Ion | Water 1 | Water 2 | Water 3 |
|---|---|---|---|
| Na⁺ | 117 | 544 | 274 |
| Ca²⁺ | 40 | 142 | 200 |
| Mg²⁺ | 10 | 37 | 50 |
| HCO₃⁻ | 100 | 269 | 100 |
| Cl⁻ | 150 | 540 | 500 |
| SO₄²⁻ | 100 | 680 | 495 |

### Example 5

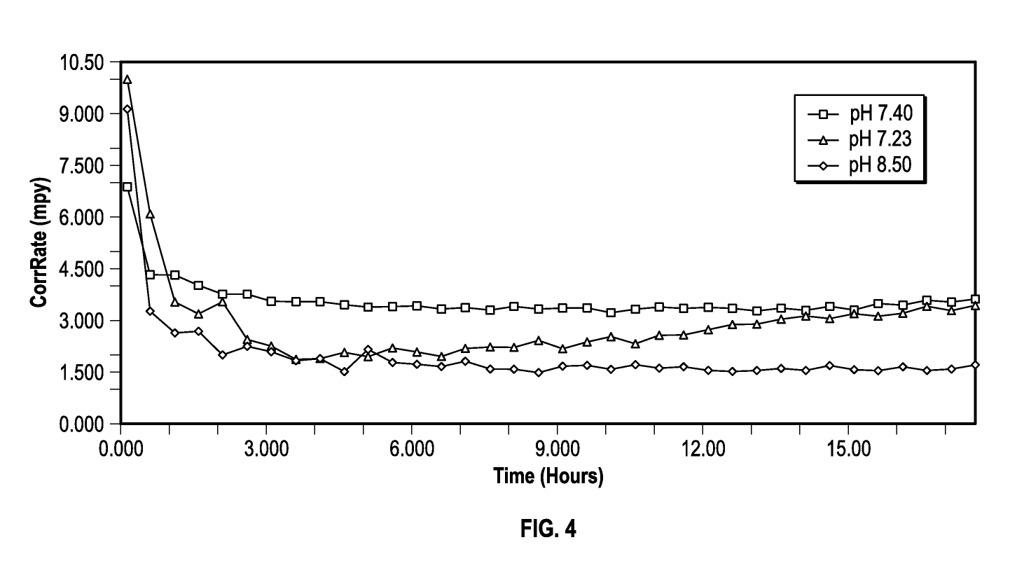

FIG. 4 is a graph illustrating the corrosion rates for aqueous systems having different pH levels. The aqueous-based fluid within each aqueous system was water, and the water chemistry included 544 mg/L Na⁺, 142 mg/L Ca⁺², 37 mg/L Mg⁺², 269 mg/L HCO₃⁻, 540 mg/L Cl⁻, 680 mg/L SO₄⁻². The system having a pH of 7.4 included 35 ppm of saccharic acid, 2.5 ppm Zn (II), 4 ppm of a calcium carbonate scale inhibitor, and 4 ppm of a calcium phosphate scale inhibitor. The system having a pH of 7.23 and the system represented having a pH of 8.5, included 35 ppm of saccharic acid, 1.5 ppm Zn (II), 4 ppm of a calcium carbonate scale inhibitor, and 4 ppm of a calcium phosphate scale inhibitor. The aqueous system having a pH of 8.5 had the lowest corrosion rate, and the aqueous system having a pH of 7.4 had the highest corrosion rate.

### Example 6

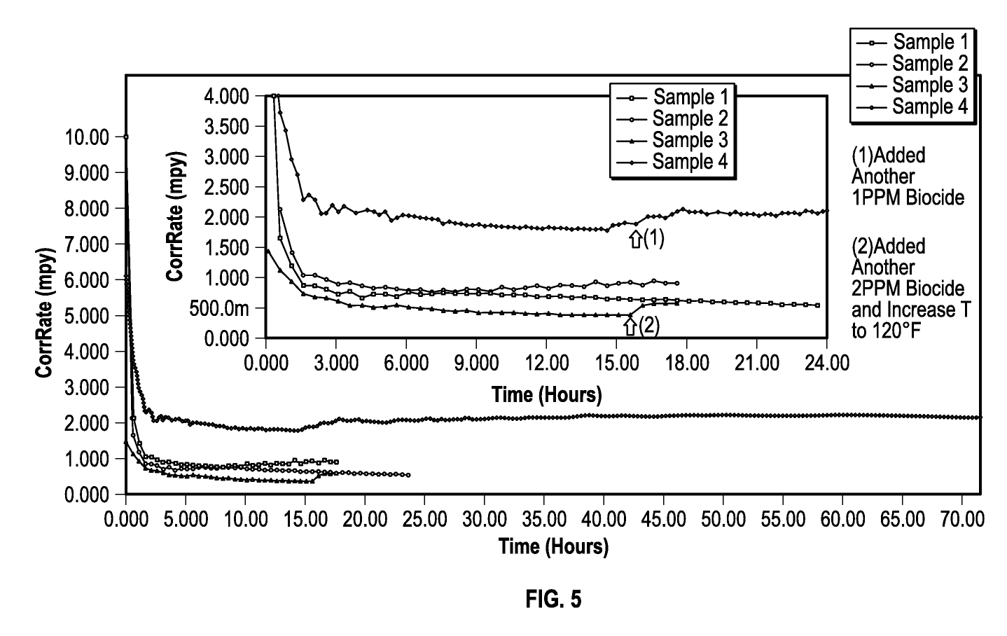

FIG. 5 is a graph illustrating the measured corrosion rates after a biocide was added to aqueous systems under different conditions. The aqueous-based fluid within each aqueous system was water, and the water chemistry included 544 mg/L Na⁺, 142 mg/L Ca⁺², 37 mg/L Mg⁺², 269 mg/L HCO₃⁻, 540 mg/L Cl⁻, 680 mg/L SO₄². The aqueous-based fluid within each system also had a pH of 8.5 and all tests were ran at 120° F. unless otherwise indicated.

50 ppm saccharic acid, 6 ppm Zn(II), 4 ppm calcium carbonate scale inhibitor and 4 ppm calcium phosphate scale inhibitor were added to Sample 1. No biocide was added to the aqueous system.

50 ppm saccharic acid, 6 ppm Zn(II), 4 ppm calcium carbonate scale inhibitor and 4 ppm calcium phosphate scale inhibitor were added to Sample 2. The aqueous-based fluid was left to stand with 2 ppm of Cl₂ (typically used as a biocide) before testing. After 72 hours, the temperature of the aqueous fluid was increased to 120° F. to measure the corrosion rates.

50 ppm saccharic acid, 6 ppm Zn(II), 4 ppm calcium carbonate scale inhibitor and 4 ppm calcium phosphate inhibitor were added to Sample 3. To the sample was also added 2 ppm of Cl₂ (typically used as a biocide). After 5 minutes, the temperature of the aqueous fluid was increased to 90° F. (about 32° C.) to measure the corrosion rates. After 15.5 hours, another 2 ppm of Cl₂ was added to the system and the temperature was increased to 120° F.

40 ppm saccharic acid, 2 ppm Zn(II), 4 ppm calcium carbonate scale inhibitor, 4 ppm calcium phosphate inhibitor, 1 ppm pTSA and 0.5 ppm Fe were added to Sample 4. After increasing the temperature of the aqueous-based fluid to 120° F., 1 ppm of Cl₂ was also added and the corrosion rate was recorded. Another 1 ppm of Cl₂ was added to the fluid after about 15 hrs and the corrosion rate measured for a total of 72 hrs.

As noted from FIG. 5, the addition of biocide (Cl₂) at different conditions still gave a low corrosion rate, no pitting corrosion observed and a clean steel coupon.

### Example 7

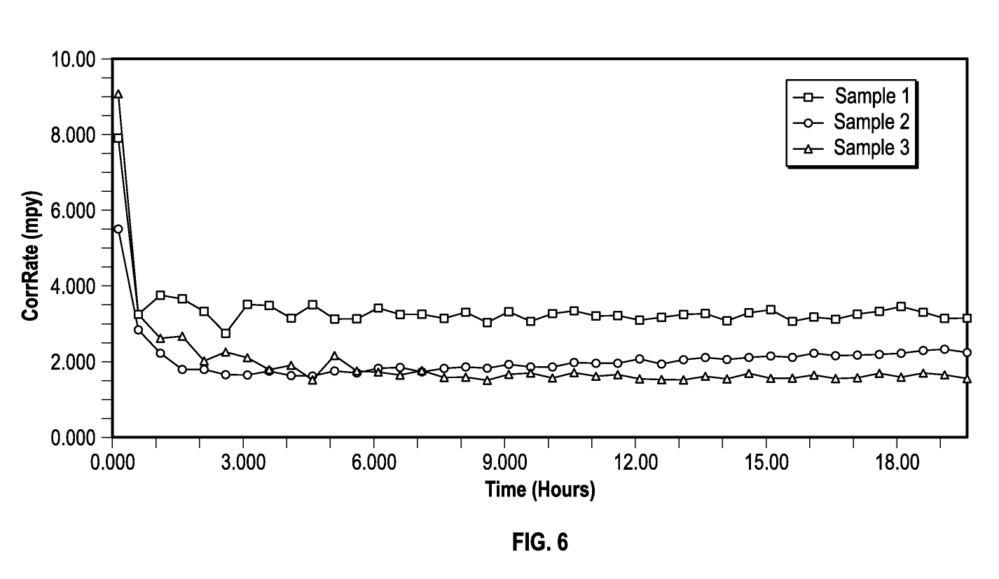

FIG. 6 is a graph illustrating the corrosion rates for aqueous systems having different taggants. The aqueous-based fluid within each aqueous system was water, and the water chemistry included 544 mg/L Na⁺, 142 mg/L Ca⁺², 37 mg/L Mg⁺², 269 mg/L HCO₃⁻, 540 mg/L 680 mg/L SO₄⁻². The aqueous-based fluid also included 35 ppm saccharic acid, 1.5 ppm Zn(II), 4 ppm of a calcium carbonate scale inhibitor, and 4 ppm of a calcium phosphate scale inhibitor. The aqueous-based fluid within each system also had a pH of 8.5.

Sample 1 included 4 ppm of Optidose (from Dow), which is an antibody labeling kit that binds to an antigen for purposes of tagging a component within the aqueous system.

Sample 2 included 1 ppm pTSA.

Sample 3 contains an “inherent tag” from the scale inhibitor used. This serves as the ‘control’ and did not have an external taggant added to the aqueous system.

### Example 8

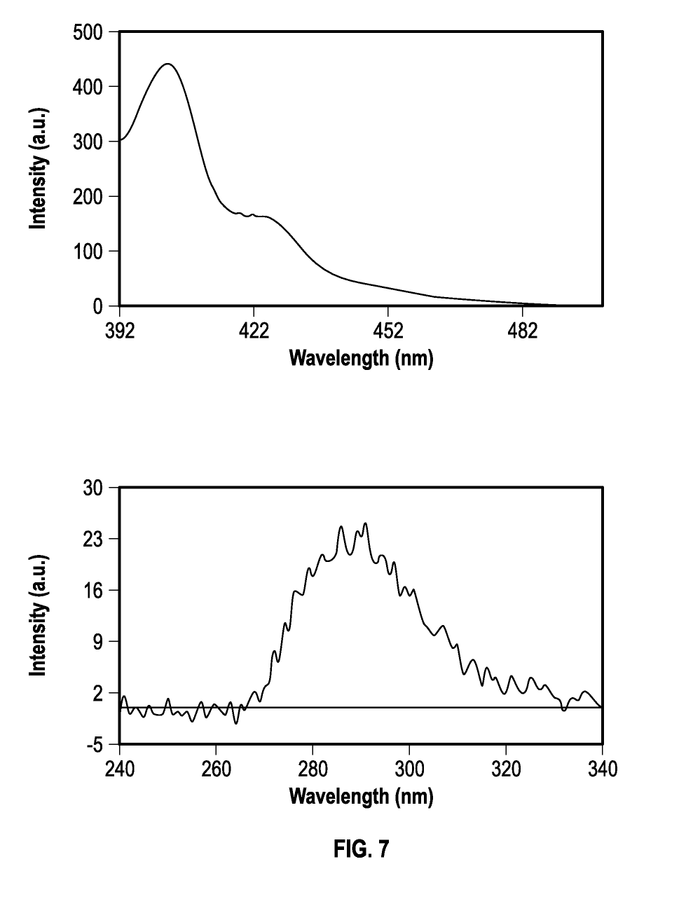

FIG. 7 is a graph illustrating the intensity of the taggants after running the system for 72 hours. The sample consisted of 40 ppm saccharic acid, 2 ppm Zn(II), 4 ppm calcium carbonate scale inhibitor, 4 ppm calcium phosphate inhibitor, 1 ppm pTSA, 0.5 ppm Fe and 2 ppm Cl₂. The water chemistry included 544 mg/L Na⁺, 142 mg/L Ca⁺², 37 mg/L Mg⁺², 269 mg/L HCO₃⁻, 540 mg/L 680 mg/L SO₄².

As noted in FIG. 7a, pTSA was still detected after 72 hours. FIG. 7b represents the intensity of the “inherent tag” used.

### Example 9

The corrosion rate of six sample systems were tested and compared. Each sample included water, and the water chemistry included 57 mg/L Na⁺, 60 mg/L Ca⁺², 0.3 mg/L Mg⁺², 122 mg/L HCO₃⁻, 114 mg/L Cl⁻, 100 mg/L SO₄², and 2 mg/L SiO₂. Each sample included 4 ppm of a calcium carbonate scale inhibitor, and 4 ppm of a calcium phosphate scale inhibitor. Each sample was tested at 120° F. MA is mucic acid, SA is sacharic acid in TABLE 3.

As noticed in TABLE 3, mucic acid decreases corrosion in the absence of saccharic acid, and mucic acid may be effective in corrosion inhibition even at low doses of 20 ppm in combination with Zn(II). Mucic acid works in the presence of a scale inhibitor, a taggant, and biocide, as well as works in combinations with saccharic acid. Mucic acid may inhibit corrosion at a pH as low as 7.25.

TABLE 3
Corrosion Rates for systems having different water chemistries

| | | | Zn | | | Cl₂ | | | Corrosion |
|---|---|---|---|---|---|---|---|---|---|
| | MA | SA | (II) | | pTSA | (free, | | Time | Rate |
| Sample | ppm | ppm | ppm | FeSO₄ g | ppm | ppm) | pH | hours | (mpy) |
| 1 | 20 | 0 | 1 | 0.0008 | 1 | 0 | 8.5 | 24 | 1.406 |
| 2 | 20 | 0 | 1 | 0.0009 | 1 | 1 | 7.45 | 48 | 1.354 |
| 3 | 4 | 16 | 1 | 0.0008 | 1 | 1 | 7.23 | 30 | 1.801 |
| 4 | 40 | 0 | 2 | 0.0012 | 0 | 0 | 8.5 | 24 | 0.8355 |
| 5 | 40 | 0 | 2 | 0.0008 | 1 | 0 | 8.5 | 24 | 0.5359 |
| 6 | 40 | 0 | 2 | 0.0008 | 1 | 1 | 8.5 | 24 | 0.7727 |

### Example 10

The ability to disperse Zn(II) was tested for different amounts of saccharic acid. Each sample included water, and the water chemistry included 434 mg/L Na⁺, 400 mg/L Ca⁺², 146 mg/L Mg⁺², 570 mg/L CO₃⁻² and 5 mg/L Zn(II). All test solutions were adjusted to pH 8.5 and were ran at 40° C. for 24 hrs. As noticed in Table 4, adding at least 40 ppm saccharic acid to the aqueous-based fluid showed a significant amount of unprecipitated Zn(II) compared to the aqueous-based fluid without the saccharic acid.

TABLE 4
Amount unprecipitated Zn(II) at different
saccharic acid concentrations.

| Amount SA | Unprecipitated |
|---|---|
| (ppm) | Zn(II) (ppm) |
| 0 | 0.125 |
| 20 | 0.15 |
| 40 | 1.04 |
| 100 | 1.06 |

In the foregoing specification, the invention has been described with reference to specific embodiments thereof, and has been described as effective in providing treated aqueous systems and methods for decreasing at least one characteristic within the aqueous system, such as but not limited to, corrosion, scale deposition and combinations thereof as compared to an otherwise identical aqueous system absent the hydroxycarboxylic acid(s) and the transition metal salt(s). However, it will be evident that various modifications and changes can be made thereto without departing from the broader spirit or scope of the invention as set forth in the appended claims. Accordingly, the specification is to be regarded in an illustrative rather than a restrictive sense. For example, specific aqueous fluids, hydroxycarboxylic acids, transition metals, transition metal salts, components, scale inhibitors, biocides, and chlorine-containing components falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method may consist of or consist essentially of adding a hydroxycarboxylic acid, and a transition metal salt to an aqueous system in an effective amount to decrease at least one characteristic within the aqueous system, such as but not limited to, corrosion, scale deposition, and combinations thereof as compared to an otherwise identical aqueous system absent the hydroxycarboxylic acid(s) and the transition metal salt(s) where adding the hydroxycarboxylic acid and the transition metal salt may occur at the same time or different times.

The treated aqueous system may consist of or consist essentially of an aqueous system, at least one hydroxycarboxylic acid in an amount ranging from about 15 ppm to about 500 ppm, and at least one transition metal salt in an amount ranging from about 0.5 ppm to about 20 ppm; the treated aqueous composition may include a decreased amount of at least one characteristic selected from the group consisting of corrosion, scale deposition, and combinations thereof as compared to an otherwise identical aqueous system absent the hydroxycarboxylic acid(s) and the transition metal salt(s).

The words “comprising” and “comprises” as used throughout the claims, are to be interpreted to mean “including but not limited to” and “includes but not limited to”, respectively.

1. A method comprising:
adding at least one hydroxycarboxylic acid and at least one transition metal salt to an aqueous system in an effective amount to decrease at least one characteristic within the aqueous system selected from the group consisting of corrosion, scale deposition, and combinations thereof as compared to an otherwise identical aqueous system absent the at least one hydroxycarboxylic acid and the at least one transition metal salt; wherein adding the hydroxycarboxylic acid and the transition metal salt occurs at the same time or different times, where:
the at least one hydroxycarboxylic acid is selected from the group consisting of saccharic acid, mucic acid, gluconic acid, and salts thereof, and combinations thereof; and
the method does not include a phosphorous-containing compound.

2. The method of claim 1, wherein the at least one hydroxycarboxylic acid comprises two or more carboxylic acid groups.

3. The method of claim 1, wherein the at least one hydroxycarboxylic acid is selected from the group consisting of saccharic acid, citric acid, and salts thereof, and combinations thereof.

4. The method of claim 1, wherein the at least one transition metal salt comprises a transition metal selected from the group consisting of Zn (II), Sn, Mn, and combinations thereof.

5. The method of claim 1, wherein the at least one transition metal salt comprises a salt selected from the group consisting of chlorides, sulfates, hydroxides, oxides, and combinations thereof.

6. The method of claim 1, wherein the effective amount of the at least one hydroxycarboxylic acid ranges from about 15 ppm to about 500 ppm.

7. The method of claim 1, wherein the effective amount of the at least one transition metal salt ranges from about 0.5 ppm to about 20 ppm.

8. The method of claim 1, wherein the aqueous system is selected from the group consisting of a cooling tower, a cooling water system, and combinations thereof.

9. The method of claim 1, wherein the aqueous system further comprises at least one component selected from the group consisting of a scale inhibitor, a biocide, a chlorine-containing component, a taggant, a yellow metal corrosion inhibitor, and combinations thereof.

10. The method of claim 9, wherein the scale inhibitor is selected from the group consisting of polyacrylates, polymaleates, hydroxypropylacrylates, phosphonates, and combinations thereof.

11. The method of claim 9, wherein the biocide is selected from the group consisting of sodium hypochlorite, chlorine dioxide, chlorine, bromine, isothiazoline, glutaraldehyde, 2,2-dibromo-3-nitrilopropionamide, and combinations thereof.

12. The method of claim 1, wherein the aqueous system has a pH greater than about 7.

13. The method of claim 1, wherein the aqueous system further comprises a chlorine-containing component in an amount greater than about 500 ppm.

14. A method comprising:
adding an additive consisting of at least one hydroxycarboxylic acid and at least one transition metal salt to an aqueous system in an effective amount to decrease at least one characteristic within the aqueous system selected from the group consisting of corrosion, scale deposition, and combinations thereof as compared to an otherwise identical aqueous system absent the at least one hydroxycarboxylic acid and the at least one transition metal salt; wherein adding the at least one hydroxycarboxylic acid and the at least one transition metal salt occurs at the same time or different times; and wherein the at least one transition metal salt comprises a transition metal selected from the group consisting of Zn (II), Sn, Mn, and combinations thereof; where:
the at least one hydroxycarboxylic acid is selected from the group consisting of saccharic acid, mucic acid, gluconic acid, and salts thereof, and combinations thereof;
the additive does not include a phosphorous-containing compound; and
the aqueous system comprises a chlorine-containing compound present in an amount ranging from about 1 ppm to about 1,000 ppm.

15. A treated aqueous system comprising:
an aqueous system;
at least one hydroxycarboxylic acid in an amount ranging from about 15 ppm to about 500 ppm selected from the group consisting of saccharic acid, mucic acid, gluconic acid, and salts thereof, and combinations thereof;
at least one transition metal salt in an amount ranging from about 0.5 ppm to about 20 ppm; and
wherein the treated aqueous composition comprises a decreased amount of at least one characteristic selected from the group consisting of corrosion, scale deposition, and combinations thereof as compared to an otherwise identical aqueous system absent the at least one hydroxycarboxylic acid and the at least one transition metal salt;
where the aqueous system does not include a phosphorous-containing compound.

16. The treated aqueous system of claim 15, wherein the at least one hydroxycarboxylic acid comprises two or more carboxylic acid groups.

17. The treated aqueous system of claim 15, wherein the at least one transition metal salt comprises at least one transition metal selected from the group consisting of Zn (II), Sn, Mn, and combinations thereof.

18. The treated aqueous system of claim 15, wherein the aqueous system is selected from the group consisting of a cooling tower, a cooling water system, and combinations thereof.

19. The treated aqueous system of claim 15 further comprising at least one chlorine-containing component in an amount greater than about 500 ppm.

20. A treated aqueous system comprising:
an aqueous system;
an additive consisting of:
at least one hydroxycarboxylic acid in an amount ranging from about 15 ppm to about 500 ppm; wherein the at least one hydroxycarboxylic acid is selected from the group consisting of saccharic acid, mucic acid, gluconic acid, and combinations thereof;
at least one transition metal salt in an amount ranging from about 0.5 ppm to about 20 ppm; wherein the at least one transition metal salt comprises at least one transition metal selected from the group consisting of Zn (II), Sn, Mn, and combinations thereof;
wherein the treated aqueous composition comprises a decreased amount of at least one characteristic selected from the group consisting of corrosion, scale deposition, and combinations thereof as compared to an otherwise identical aqueous system absent the at least one hydroxycarboxylic acid and the at least one transition metal salt; where:
where the additive does not include a phosphorous-containing compound and the aqueous system comprises a chlorine-containing compound present in an amount ranging from about 1 ppm to about 1,000 ppm.
